(19) United States
(12) Patent Application Publication
(10) Pub. No.: US 2012/0253930 A1
(43) Pub. Date: Oct. 4, 2012

(54) USER INTENT STRENGTH AGGREGATING BY DECAY FACTOR

(75) Inventors: Bin Gao, Beijing (CN); Tie-Yan Liu, Beijing (CN); Jun Yan, Beijing (CN); Ning Liu, Beijing (CN); Dou Shen, Bellevue, WA (US); Ying Li, Bellevue, WA (US)

(73) Assignee: Microsoft Corporation, Redmond, WA (US)

(21) Appl. No.: 13/078,300

(22) Filed: Apr. 1, 2011

(51) Int. Cl. G06Q 30/00

(52) U.S. Cl. 705/14.53

(57) ABSTRACT

This application describes a system and method for estimating user intent towards categories of content. The estimation of user intent may be based at least in part on a score for prior user actions and a decay function that is applied to that score to provide an estimate of current user intent. The estimate represents current user intent for time periods in which user actions towards a category of content are negligible or non-existent.

### BACKGROUND

Advertising to internet users is an important branch in the online advertising market. A key concern for display advertising is presenting timely and relevant advertisements to users who are intent on making a purchase in the future. In short, advertisers prefer placing or locating advertisements online that will have a high click through rate (“CTR”) and conversation rate. The CTR is typically defined as a ratio of how many users clicked on an ad over the number of times the ad was displayed online and conversion rate is defined as a ration of how many users convert (take certain transactions) over the number of clicks. Hence, ads with high CTR's and conversion rates are more likely to be cost effective than ads with low CTRs and conversation rates. The former is more likely to draw higher sales for advertised products or services. Accordingly, ad placement services may be able to charge a premium for ads that are more likely to obtain a higher click through rate and conversion rate by presenting ads to users that have or will have interest in particular categories of products and services. However, estimating user interest or intent regarding particular categories of products or services is difficult.

### SUMMARY

This Summary is provided to introduce the simplified concepts for determining user intent over a period of time based at least in part on a decay factor that is applied to scores generated from historical user behavior. The methods and systems are described in greater detail below in the Detailed Description. This Summary is not intended to identify essential features of the claimed subject matter nor is it intended for use in determining the scope of the claimed subject matter.

User intent targeting systems record and analyze user browsing and searching behavior, as well as all other signals we can obtain for users, (i.e., social networks, user locations, age, gender, and income) to quantify user intent or interest in purchasing products or services. User intent scores may be assessed based on user actions, and this intent to purchase a product or service may linger after the initial user activity. For example, a user may search for a product or service on a Monday indicating a high interest in a category of products. However, while the user's actions on Tuesday and Wednesday may not be directed to that category of products but, the user may still have an interest in the category of products despite the lack of direct user activity to those products on those particular days. Hence, a decay factor may be applied to an initial user intent score to capture or estimate the lingering user intent. The decay factor may be tailored to the type of product or service to represent the likely lingering interest for the product or service.

User intent may decline at various rates based upon the type of category being browsed or searched. For example, a user may decide to purchase fast food in less than one hour, whereas the intent to purchase an automobile may last for several days, weeks, or even months. Hence, user intent for purchasing fast food may decline at a faster rate than user intent related to purchasing an automobile. Accordingly, the decay rate may vary between categories of products and services advertised on the internet. Furthermore, the decay models may be based on linear, square root, and elliptical models.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment that includes a user operating a computing device to browse or search the internet and a server that determines a user intent score based on user behavior over time.

FIG. 2 illustrates an example process that the server of FIG. 1 may implement to determine user intent towards categories of products and services advertised on the internet.

FIG. 3 illustrates a representative decay function with tables illustrating how the variables of the decay function apply to user intent over time.

FIG. 4 illustrates another representative decay function with tables illustrating how the variables of the decay function apply to user intent over time.

FIG. 5 illustrates yet another representative decay function with tables illustrating how the variables of the decay function apply to user intent over time.

FIG. 6 illustrates another example process that the server of FIG. 1 may implement to determine user intent towards categories of products and services advertised on the internet.

FIG. 7 illustrates yet another example process that the server of FIG. 1 may implement to determine user intent towards categories of products and services advertised on the internet.

### DETAILED DESCRIPTION

### Overview

This disclosure describes, in part, systems and techniques for assessing user intent or interest in products and services being advertised over the internet. To do so, the system and techniques may utilize multiple different algorithms to determine user intent over time. The system quantifies user intent towards products and services and groups users based on similar intent scores. Advertisers are offered access to the various groups at various pricing points. For example, the cost of advertising to user groups showing a stronger or higher intent towards a particular product or service may be greater than the cost of advertising to user groups showing a lesser intent towards the product or service. The techniques described above and below may be implemented in a number of ways and contexts. Several example implementations and contexts are provided with reference to the following figures, as described in more detail below. However, the following implementations and contexts are but a few of many.

### Example Environment

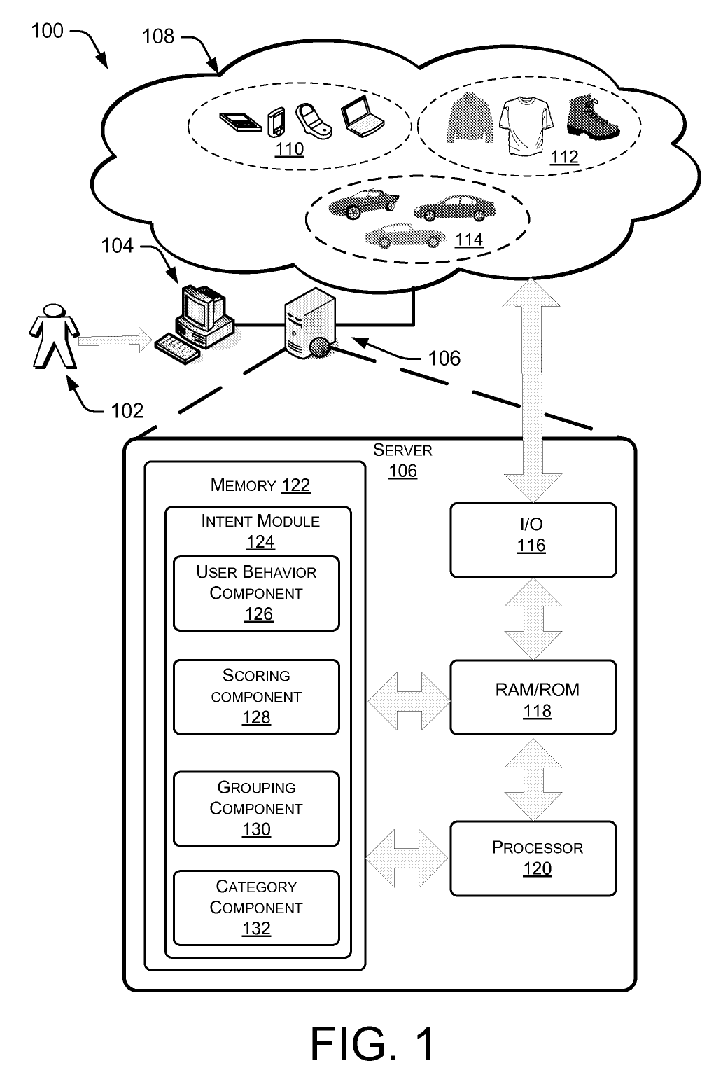

FIG. 1 illustrates example environment 100 that may implement the described techniques. The example environment 100 may include a user 102, a computer 104, and a server 106 that enables the user to access content on the internet 108.

As is known, the internet 108 comprises a global system of interconnected computer networks that serve content to devices, such as the computer 104 of the user 102. The internet 108 may include a number of different content providers that provide varying types of content to these devices. On the internet 108 (or on any other network), information served by these content providers may be associated with different categories of items. Some of these items (e.g., products and services) may be purchased by the user 102 and other users via the internet 108. As such, content providers may advertise these items in an attempt to elicit purchases by the user 102 and other users.

By way of example and not limitation, items offered on the internet 108 or another network may be categorized into an electronics category 110, a clothing category 112, and an automobile category 114, although available items may be categorized in any other way in different embodiments. The categories may also include sub-categories in which products services may be further defined. For example, the electronics category may include sub-categories for computers, laptops, smart phones, game consoles, and/or home appliances. Further still, the computer sub-category may also include additional sub-categories based on the type, model, or manufacturer of the computer. Moreover, a taxonomy may be generated to easily segregate the products and services available over the internet 108 into categories that may be used to implement the techniques described below. The concept of the taxonomy will be described in greater detail below, but the following first provides a high level description of the system followed by more details of its relevant components.

As illustrated, the user 102 may interface with a computer 104 that enables the user to browse and search the internet 108 via the example server 106. While FIG. 1 illustrates one example, the user 102 may interact with the internet 108 in a myriad of ways that may include a mobile device, a smart phone, a laptop over a wireless network, or the like. At a high level, the server 106 may store, track, and/or analyze the actions of the user 102 or users over the internet 108 to quantify the intent of the user(s) to towards various categories. Further, while the proceeding discussion describes the server 106 as tracking the user's actions, this tracking may be achieved locally on the computer 104, at another entity, or at any combination thereof. In some instances, the server 106 may group a number of users together based on their intent scores associated with a category and then offer advertisers variable rates for each group in order to place ads in front of those users. Advertisers pay more to place ads in front of groups of users that have higher intent scores over groups of users that have lower intent scores. For example, an electronics advertiser may pay a higher price for a user having a particularly high user intent score for electronics than would an automobile advertiser. Further, and as noted above, the level of user intent may change over time and a decay function may be applied to the intent score to account for changes in user intent over time. The details of these techniques will be described in greater detail below.

As illustrated, the server 106 may include interface component 116 coupled to RAM/ROM 118 and a processor 120. The hardware configuration enables the sending and receiving of data or information between the computer 104 and the internet 108. The server 106 may also include a memory component 122 that includes an intent module 124 that performs the scoring and grouping discussed above. The intent module 124 may comprise a user behavior component 126, a scoring component 128, a grouping component, and a category component 132 that may be used to provide intent scores associated with the user(s) 102 related to any or all of the categories and/or sub-categories of the products or services advertised over the Internet 108. The details of each component are segregated here for ease of explanation, but one of ordinary skill in the art would realize that the components of the intent module 124 (and/or any other module described herein) may reside on different servers or computers and that the functions of the components may be performed by any combination of the components described.

In one instance, the user behavior component 126 may track the user page views and search requests of the user 102. The user behavior component 126 may aggregate user behavior into various periods of time to segregate user activity into discrete time periods. The time periods may range between weeks, days, hours, or minutes or what ever time period is most appropriate to the category being analyzed. In short, the user behavior component 126 may be configurable to track and aggregate user actions over various periods of time that may reflect the reasonable ebb and flow of user intent or interest based on certain aspects that may define how long a user may have an interest in the category. The amount of time a user may be interested in a category may be variable dependent upon several factors, such as expense, time to purchase, ease of purchase, and/or other factors. Users may spend more time considering whether or not to purchase an expensive item over an inexpensive impulse item, and may spend less time considering whether or not to purchase a time limited item, such as lunch. For example, user intent in a fast food category may be limited to a short amount of time based on the fact the user may be intent on eating lunch within the hour. In contrast, user intent in a food recipe category may be relevant for longer period of time based on a user's desire to cook a meal at the end of a day, end of a week, or at the end of the month (e.g., birthdays, anniversaries, Thanksgiving, etc.). Likewise, user intent related to selecting a cooking appliance may be considered over days, weeks, or months as users may take longer to make decisions regarding more expensive purchases. Hence, the intent module administrator may define a variety of time periods in order to best assess or monitor user intent based on the characteristics of each category. Following the aggregation of user actions by the user behavior component 126, the user actions may be quantified to rank user intent.

The scoring component 128 quantifies the user actions tracked by the user behavior component 126 to generate a current user intent score that indicates the current user intent for the most recent time period towards a category or sub-category. A “user intent score” is indicative of how interested a user is in a particular category or sub-category and, hence, how likely it is that the user would click through an advertisement associated with an item from that category or sub-category if presented to the user. Prior user intent scores are reflective of a score associated with a previous time period and the same user that is assigned the current user intent score. Hence, the current user and prior user terminology is an indication of a different time period and not representative of a different user of the computer.

The scoring component 128 may also store the intent scores over time or they may be stored by the user behavior component 126 or the grouping component 130 as well. The current user intent score may be based on a single action over a period of time or it may be cumulative of several user actions of a period time. For example, the user 102 may make several searches or page views that may be related to the same category or sub-category; hence those actions may be cumulated to generate the current user intent score.

Many different methods may be used to generate a score related to user actions based on what a person of ordinary skill in the art of statistics and search technology. For example, scores could be modeled based upon a vector space model for keywords that represent keywords via vectors that enable the assignment of various weights to different keywords that apply to category. For example, the keyword “software” may be assigned a lower score than “Microsoft™ Office” for a Microsoft™ category, but they may have the same score for a broader category such as a generic software category. Once the score has been determined it is associated with a particular time period in which the actions used to generate the score belong. The combination of the score and associated time period may be utilized to track user intent over time. The scoring component 126 or the grouping component 130 may store the score and time period and function as a historical database of user(s) actions related to one or more categories.

Moreover, the scoring component 128 may generate a score for successive time periods which have no recorded user actions. Hence, the score for those time periods may be zero or a negligible amount that maybe approximated to be zero. However, a score of zero may not be a true reflection of user intent towards a category. The user intent may not have diminished entirely as indicated by a zero score during the non-active time period. For example, the user may at work or at school and is unable to initiate keyword searches or pages views during that time period. Accordingly, the score component 128 may apply a decay function to the most recent prior user intent score to reflect the lingering intent of the user during time periods that receive a zero or negligible score.

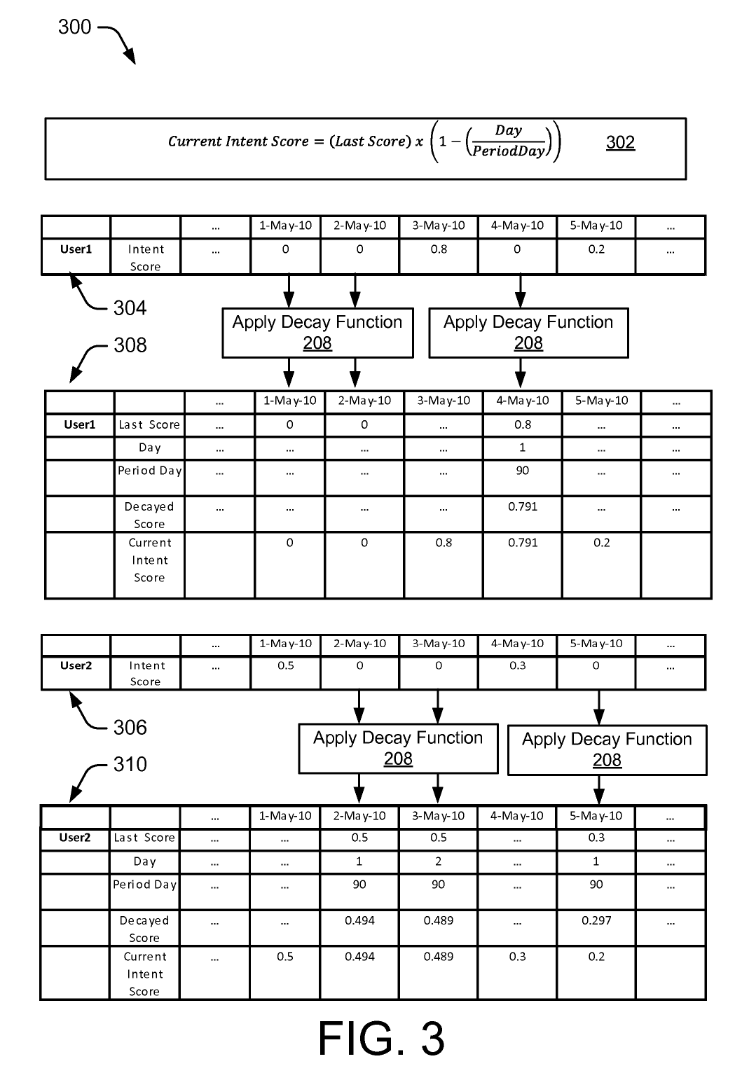

Based on the characteristics of the category associated with the score, the decay function may diminish the most recent prior user intent score to reflect the lingering intent of the user, even though no actions are being recorded by the user behavior component 126 during the non-active time periods. This approach reduces variability in the scoring data which provides a more predictive result of actual user's intent over time. The details of how to apply the decay function to generated user intent scores will be described in greater detail in FIGS. 3-5. For the time being, the decay function will be applied to the most recent user intent score until the user intent score is diminished to zero or the user behavior component 126 detects a new user action directed towards the relevant category. At that time, the scoring component 128 generates a current user intent score to replace the decayed user intent score. This process of applying the decay function will repeat until a new user action towards the relevant category is detected. The scores generated by the scoring component 126 may be aggregated by the grouping component 130 to collate the users into groups that reflect a relative likelihood of higher or lower click through rate for advertisements.

The grouping component 130 aggregates the current user intent scores by category, and places users into groups based upon their current user intent score. The groups may be based at least in part on predetermined score ranges or calculated ranges based on the number of users and their relative scores. By way of example and not limitation, users with higher current user intent scores for a particular category are grouped together and users with lower current user intent scores for the same category are grouped together. The amount of groups can vary and may include three or more groups per category. The higher current user intent score groups are more likely to have a higher click through rate that is desired by advertisers. However, the number of users within the higher group may likely contain a smaller amount of users than groups formed by users with lower current user intent scores. So advertisers may pay more money for access to users with higher intent scores or they may pay a lower amount to gain access to a larger amount of overall users for their ads. A person of ordinary skill in the art of advertising or statistics may arrange the users associated with one or more categories into groups based on a strategy that will appeal to advertisers.

The intent module 124 may also include a category component 132. The category component stores the taxonomy of products and services that are likely to be advertised on the internet 108 or any other network or predefined domain (e.g., a particular website, etc.). An intent module administrator may provide the taxonomy to the category component 130 or the category component 130 may include an algorithm that generates categories and sub-categories for products and services found on the internet 108. A person of ordinary skill in the art of classification or taxonomy would know how to classify and categorize the products and services that may be advertised or displayed on the internet 108. An example taxonomy for vehicles is provided below in Table 1.

TABLE 1

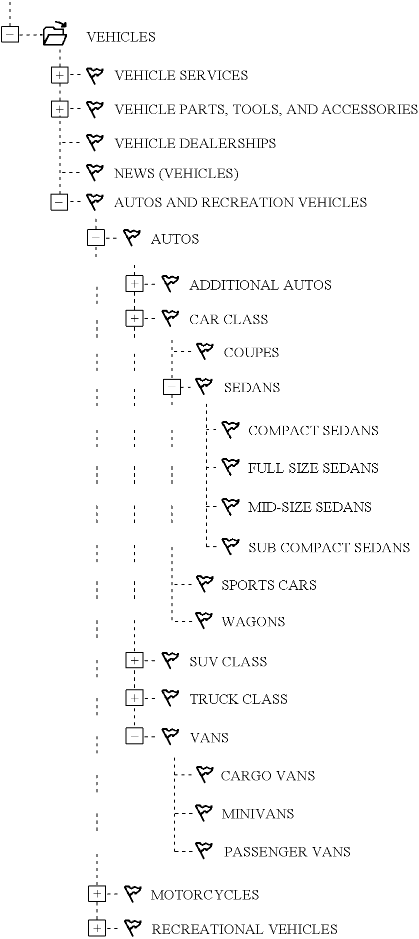

As shown in FIG. 1, the intent module 124 is stored in memory 122 and interfaces with the RAM/ROM 118 to receive data from computer 104. In one instance, the RAM/ROM 118 and the memory 122 of server 106 may be comprised of any computer-readable media. The computer-readable media includes, at least, two types of computer-readable media namely computer storage media and communications media. Computer readable media includes volatile and non-volatile, removable and non-removable media implemented in any method or technology for storage information such as computer readable instructions, data structures, program modules, program components, or other data. Computer storage media includes, but is not limited to, RAM, ROM, EEPROM, flash memory, or other memory technology, CD-ROM, digital versatile disks (DVD), other optical storage technology, magnetic cassettes, magnetic tape, magnetic disk storage, or other magnetic storage devices, or any other non-transmission medium that can be used to store information for access by a computing device. In contrast, communication media may embody computer-readable instructions, data structures, program modules, or other data in a modulated data signal, such as carrier waves, or other transmission mechanisms. As defined herein, computer storage media does not include communication media. One of ordinary skill in the art would contemplate the techniques for executing the computer-readable instructions via the processor 120 in order to implement the techniques described herein.

### Example Process for a Decayed Intent Score

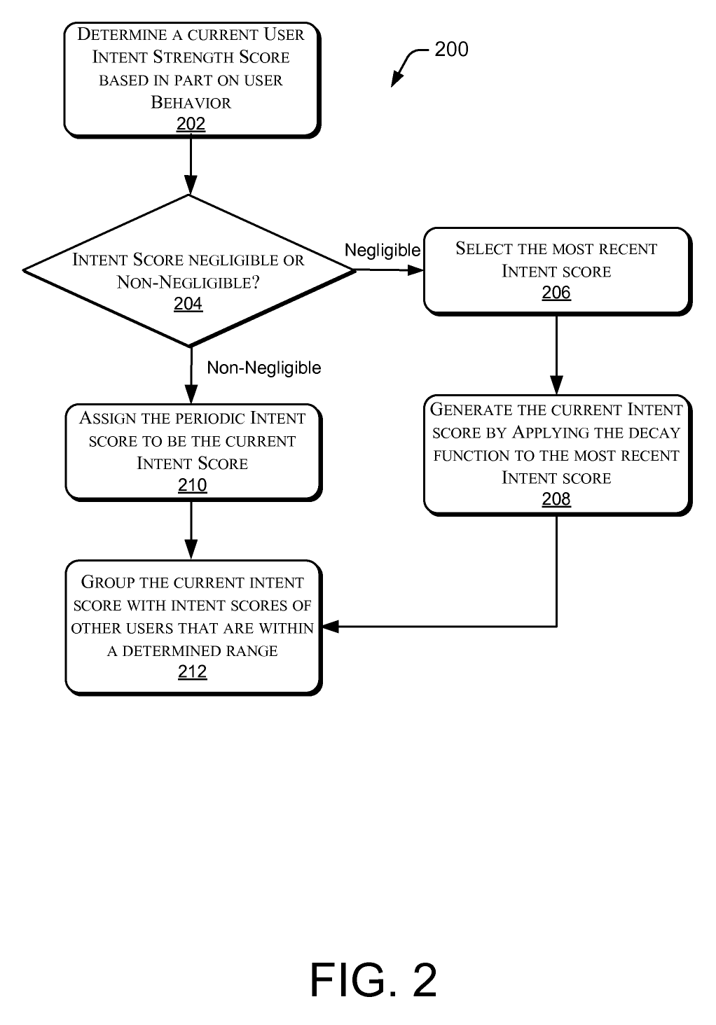

FIG. 2 illustrates an example process 200 that the server 106 of FIG. 1 may implement for determining user intent towards categories of products and services advertised on the internet 108. While this and other processes described herein discuss the server 106 implementing some or all of the operations, other servers and/or clients may implement some or all of these operations in other instances. Note that the order in which the process is described is not intended to be construed as a limitation, and any number of the described acts can be combined in any order to implement the process, or an alternate process. Additionally, individual blocks may be implemented in parallel with one another or deleted altogether from the process without departing from the spirit and scope of the subject matter described herein.

At 202, the intent module 124 determines an intent strength score based in part on user behavior being monitored by the user behavior component 126. User actions are monitored over a time period, the time period may of any length or duration desired by the intent module administrator. The user actions performed within each time period are analyzed to generate a current user intent strength score for each time period. The intent strength score may be representative of a user's intent or interest in a category of content located on the internet 108. Three aspects can define user intent in some instances: semantics, preferences, and pragmatics, based on which the users can then achieve their goals in a more timely and efficient manner. The pragmatic portion of the intent definition defines the steps and activities that can be performed to achieve a task. The topical expressions, along with associated attributes and actions are represented in an intent structure, which illustrates relationships between various topical expressions. An algorithm is then used to map keywords from user data to the intent structures to infer current and future user intent. One example algorithm may be found in U.S. patent application Ser. No. 12/790,523 entitled “Defining User Intent.” In one instance, the scoring component 128 may generate the intent strength score by applying any available or desired scoring technique to the user action information captured by the user behavior component 126.

At 204, the scoring component 128 determines if the intent strength score is a non-negligible value or negliglible. An intent module 124 administrator may set the limits or threshold on which values may be deemed negligible.

At 206, if the current user intent score is negligible, the scoring component 126 selects the most recent user intent score that was generated directly by user actions. For example, the scoring component 126 would determine the most recent time period in which the user performed a user action that was recorded by the user behavior component. Additional explanation of how to select the most recent user intent score will be provided in the remarks for FIG. 3.

At 208, the scoring component 126 generates the current user intent score by applying a decay function to the most recent user intent score. In one instance, the decay function is a linear function that decreases the most recent intent score in a linear manner over time. In one instance, the decay function will decrease the most recent user intent score equally for each successive time period in which a user action is not detected. The amount of the decrease applied to most recent user intent score may be set by the intent module administrator. In another instance, the decay function is based in part on a ratio a number of time periods between the most recent time period and a nearest time period in which the prior user intent score was determined to be non-negligible, and a number of time periods over which the most recent prior user intent score will decay a negligible amount. In one instance, the decay function may be implemented as shown in equation (1) below.

$$Current Intent Score = ( Most recent user intent score ) \times ( 1 - ( \frac{Day}{PeriodDay} ) ) \qquad ( 1 )$$

Wherein the Day variable is an indication of how many time periods (e.g., days, hours, minutes) have elapsed since a current user intent score was generated based on an actual user action. The Period Day variable, meanwhile, is an indication of how many time periods (e.g., days, hours, minutes) the most recent user intent score will need in order to decay to negligible. The Period Day is an amount that may be determined the administrator of the intent module 124. An example of how to implement the above decay function is discussed in FIG. 3.

In another instance, the decay function may also include a square root function. For example, see equation (2):

$$Current Intent Score = ( Most recent user intent score ) \times \sqrt{1 - ( \frac{Day}{PeriodDay} )} \qquad ( 2 )$$

In another instance the decay function may also include a square root function and an exponential function. For example, see equation (3):

$$Current Intent Score = ( Most recent user intent score ) \times \sqrt{1 - {( \frac{Day}{PeriodDay} )}^{2}} \qquad ( 3 )$$

At 210, if user intent score is non-negligible, the scoring component 126 assigns the non-negligible value to be the current user intent score. The decay factor is not applied to user intent scores when the user intent score is non-negligible, hence the intent score that is based on an actual user action becomes the current user intent score.

At 212, the current user intent score, either calculated by the decay function equations above or generated by actual user actions, is sent to the grouping component 130. The grouping component 130 groups the current intent score with other user's intent scores that are within a determined range.

FIG. 3 is an illustration of a scenario 300 implementing equation (1) 302 for two users 304, 306 using the intent module 124 to determine a user intent score. User 1 table displays the intent scores for a user over a five day time period (May 1, 2010-May 5, 2010) that is generated by the user behavior component 126 and/or the scoring component 128 based on actual user actions. User 1 does not initiate any user action on May 1^{st}, 2^{nd}, and 4^{th}, but does initiate user actions on May 3^{rd} and 5^{th}, as shown in table 304 via the intent scores. In this instance, we are assuming no user actions exist prior to May 1; the most recent user intent score or last score is negligible (e.g., zero in some instances) as shown in table 308. Applying the decay function as described in step 208 using equation (1), the current intent score is zero for May 1^{st} and 2^{nd}, as shown in table 308. However, on May 3^{rd}, the behavior component 126 detects user actions which are scored as 0.8 by the scoring component 128. As described in step 210, since the intent score is non-negligible (e.g., non-zero in some instances), the number generated by the scoring component 128 becomes the current intent score, 0.8, as shown in table 308. But on May 4^{th}, the user behavior component 126 does not detect any user actions and the scoring component 128 assigns a zero value for the intent score. Therefore, as described in step 208, the scoring component applies equation (1) using the most recent intent score or the last score. As shown in table 308, the most recent score or last score is 0.8, the amount of time periods since the last score is 1, hence the Day variable is 1, and the Period Day is set at 90 by the intent module administrator. Using those values in equation (1) 302, the decayed score is 0.791 and the scoring component 128 assigns 0.791 to be the current user intent score. The current intent score may be sent to the grouping component 130 instead of the zero intent score which was based on the user not taking any actions during the time period of May 4^{th}. Lastly, on May 5^{th}, the behavior component 126 detects a user action and the scoring component 128 assigns a score of 0.2. As described in step 210, since the intent score is non-zero, the number generated by the scoring component 128 becomes the current intent score, 0.2, as shown in table 308.

In another aspect of scenario 300, user 2 initiates actions on May 1^{st} and May 4^{th}, as shown in table 306. Accordingly, on May 2^{nd}, 3^{rd} and 5^{th} the scoring component 128 applies the decay function since no user actions were detected by the user behavior component 126 on those days, as shown in table 306. On May 2^{nd}, the Day variable is 1, since the last time a user action was detected was one day prior, and the Period Day variable is set at 90, as shown in table 310. Applying the variables to equation (1) 302, the decayed score for May 2^{nd} is 0.494 which is assigned as the current intent score in lieu of the zero score that was based on the user behavior component 126 not detecting any user actions on May 2^{nd}. Again, on May 3^{rd}, the user behavior component 126 does not detect any user actions and the scoring component 128 generates an intent score of zero. But, the scoring component 128 also applies the decay function, as described in step 208. As shown in table 310, the Day variable is 2, since the last time period when the user behavior component detected a user action was two days prior. Again, the Period Day variable is 90 resulting in a decayed score of 0.489 which is assigned as the current intent score for May 3^{rd}. However, on May 4^{th}, due to the new actions of the user detected by the user behavior component 126, the current intent score is set at 0.3 without applying the decay function, as described in step 210. But, on May 5^{th}, the user behavior component 126 does not detect any user action and the scoring component applies the decay function making the current user intent 0.2 for May 5^{th}, as shown in table 310.

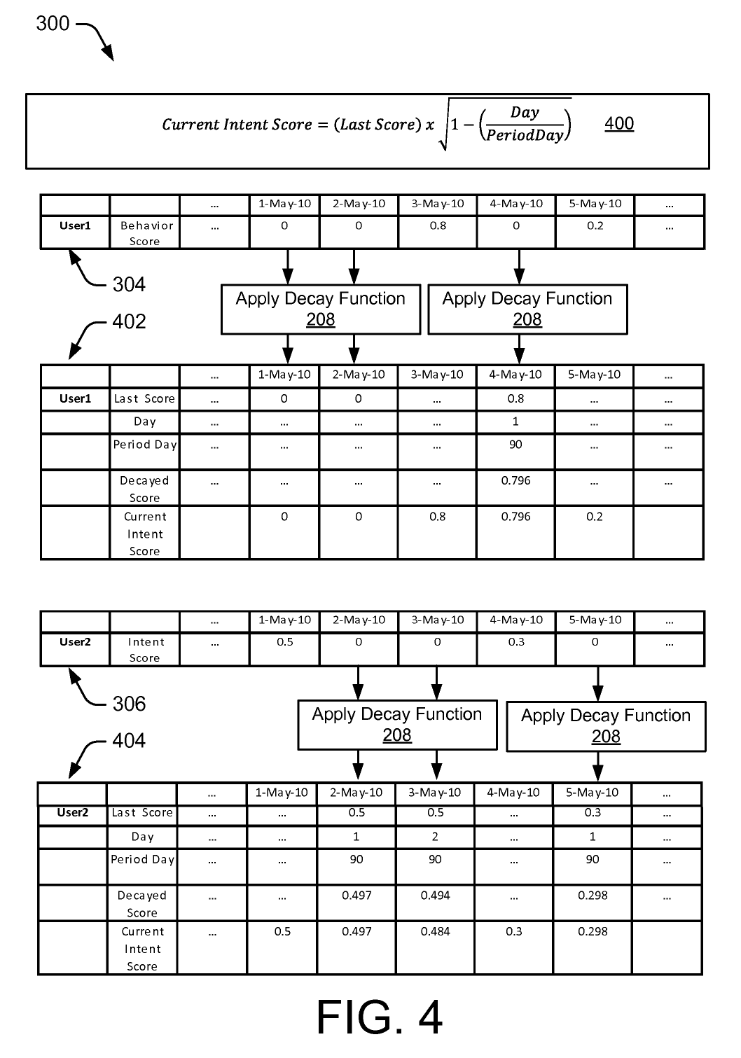

FIG. 4 is an illustration of a scenario 300 implementing equation (2) 400 for two users 304, 306 using the intent module 124 to determine a user intent score. User 1 table displays the intent scores for a user over a five day time period (May 1, 2010-May 5, 2010) that is generated by the user behavior component 126 or the scoring component 128 based on actual user actions. Tables 304 and 306 describe the same time period scenario 300 discussed in FIG. 3. However, tables 402 and 404 show the implementation of equation (2) 400 as applied to scenario 300. Accordingly, the time periods in which the decay function is applied the current intent scores is different. Hence, tables 402 and 404 show that the current intent scores for scenario 300 are different than when equation (2) 400 is applied instead of equation (1) 302 as shown in FIG. 3.

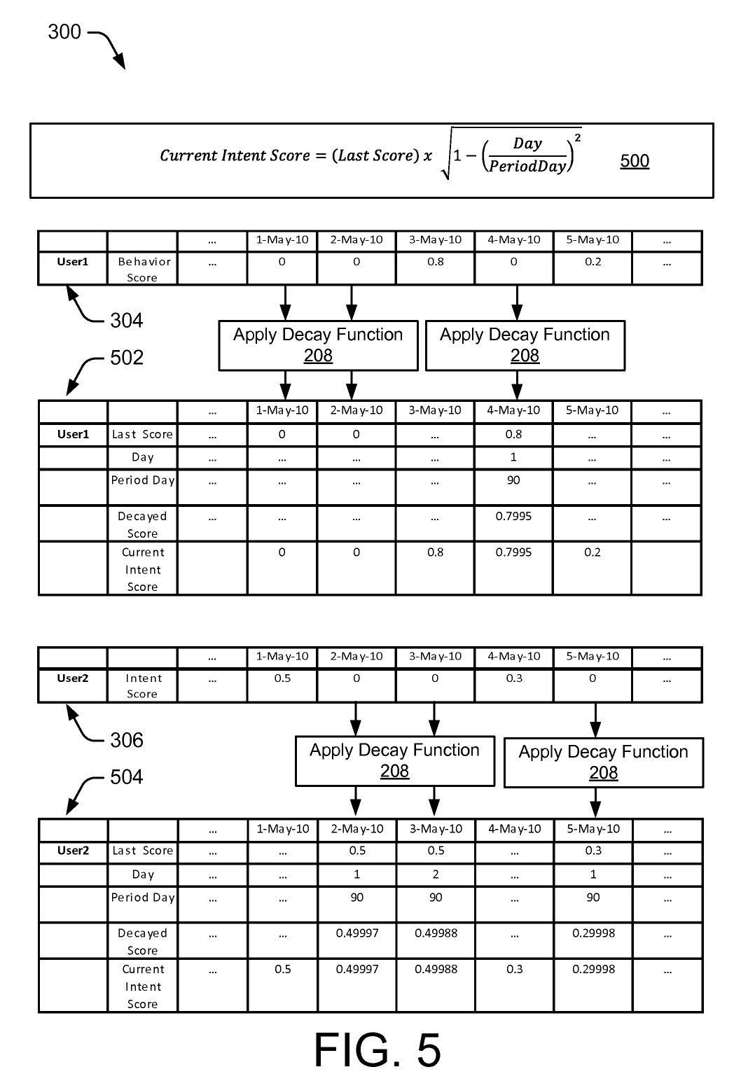

FIG. 5 is an illustration of a scenario 300 implementing equation (3) 500 for two users (304, 306) using the intent module 124 to determine a user intent score. User 1 table displays the intent scores for a user over a five day time period (May 1, 2010-May 5, 2010) that is generated by the user behavior component 126 or the scoring component 128 based on actual user actions. Tables 304 and 306 describe the same time period scenario 300 discussed in FIG. 3. However, tables 502 and 504 show the implementation of equation (3) 500 as applied to scenario 300. Accordingly, the time periods in which the decay function is applied the current intent scores is different. Hence, tables 502 and 504 show that the current intent scores for scenario 300 are different than when equation (3) 500 is applied instead of equation (1) 302 as shown in FIG. 3.

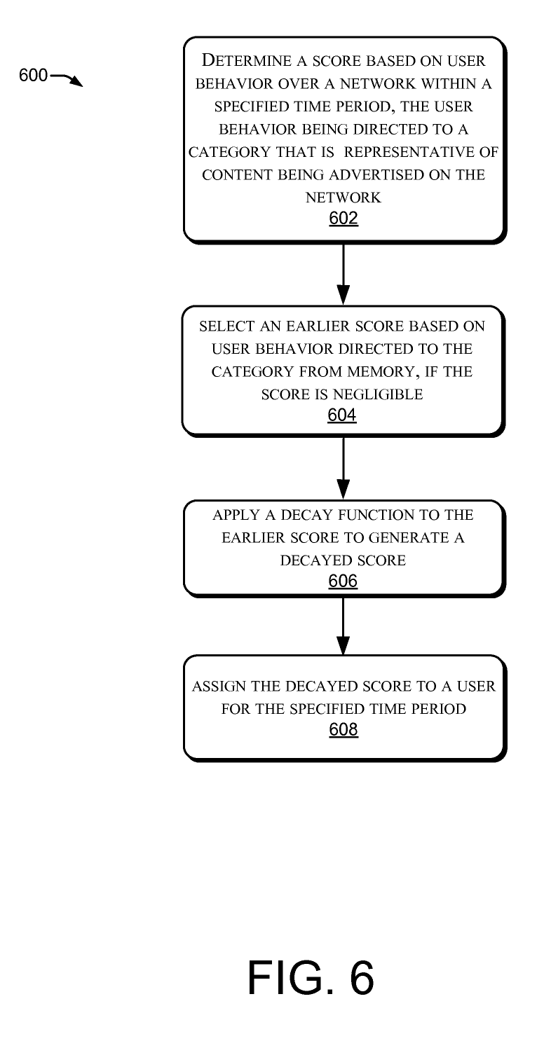

FIG. 6 illustrates an example process 600 that the server 106 of FIG. 1 may implement for determining user intent towards categories of products and services advertised on the internet 108. While this and other processes described herein are described with reference to the architecture of FIG. 1, other architectures may implement these processes.

At 602, the intent module 124 determines a score for user behavior over a network within a specified time period. This time period may be set by the administrator of the intent module 124. In this instance, the score is associated with user actions directed to a category of content found on the internet 108 or another network. The category may be, but is not limited to, electronics 110, clothes 112, automobiles 114, or another type of category.

At 604, if the score in step 602 is negligible, the intent module 124 may select an earlier score that was determined based on user actions directed to the same category. The negligible score is an indication that the user did not perform actions attributable to the category during the specified time period. Hence, the intent module 124 may select an earlier score to estimate the current intent of the user during the specified time period.

At 606, the intent module 124 applies a decay function to the earlier selected score to generate a decayed score that is an estimate of the current user intent during the specified time period in which no user actions were detected. The decayed score may be determined by using equations (1), (2), or (3) as noted above in the remarks to FIGS. 2-5.

At 608, the intent module 124 assigns the decayed score to be the current user intent score for the specified time period.

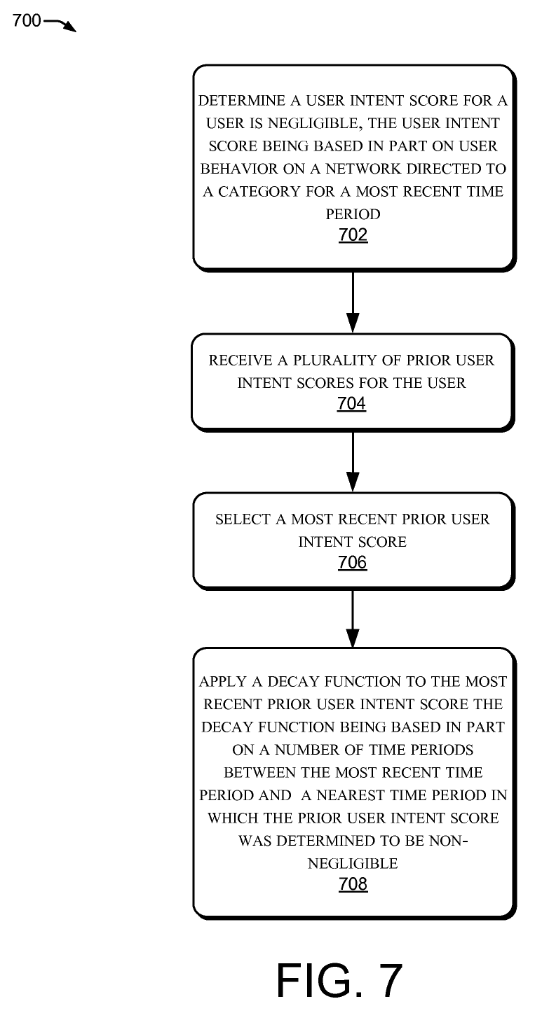

FIG. 7 illustrates an example process 700 that the server 106 of FIG. 1 may implement for determining user intent towards categories of products and services advertised on the internet 108 or another network.

At 702, the user intent module 124 determines that for a certain time period a score that is of a negligible amount based on the amount of user actions that are directed to a category of content on the Internet 108.

At 704, on the basis of the negligible score, the intent module 124 retrieves a plurality of prior user intent scores that are associated with the category. The prior scores are from time periods prior to the time period at step 702. In these instances, the intent module 124 may have stored the prior user intent scores in sequential order.

At 706, the intent module 124 selects the most recent prior user intent score as described in FIG. 3. In another embodiment, the intent module 124 may select more than one prior score in order to determine an average or median score based on a plurality of prior scores.

At 708, the intent module 124 applies a decay function to the selected user intent score of step 706. The decay function based at least in part on a number of time periods between the most recent time period and a nearest time period in which the prior user intent score was determined to be non-negligible and a number of time periods over which the most recent prior user intent score will decay to a negligible amount.

### CONCLUSION

Although the embodiments have been described in language specific to structural features and/or methodological acts, is the claims are not necessarily limited to the specific features or acts described. Rather, the specific features and acts are disclosed as illustrative forms of implementing the subject matter described in the disclosure.

What is claimed is:

1. A method comprising:
determining, using a processor, a score based on behavior of a user on a network within a specified time period, the behavior of the user being directed to a category that is representative of content that is being advertised on the network;
when the determined score is less than a predefined threshold:
selecting an earlier score that is based on behavior of the user on the network that is also directed to the category and that occurred prior to the specified time period;
applying a decay function to the earlier score to generate a decayed score; and
assigning the decayed score to the user for the specified time period.

2. The method of claim 1, further comprising:
when the determined score is greater than the predefined threshold, assigning the determined score to the user for the specified time period.

3. The method of claim 2, further comprising:
grouping the user with a plurality of users that each have a score that is within a specified range or a statistically determined range of the score of the user;
assigning an advertising fee to the group of users, the advertising fee being based on the score of the user or the specified or statistically determined range.

4. The method of claim 1, wherein the category is a first of multiple categories of a taxonomy of products or services being advertised on the network.

5. The method of claim 1, wherein the behavior of the user comprises the user submitting a search query on the network or the user viewing a page on the network.

6. The method of claim 1, wherein the specified time period is measure in days, hours, or minutes.

7. A method comprising:
determining that a user intent score for a user is negligible, the user intent score being based at least in part on user behavior on a network directed to a category for a most recent time period;
receiving a plurality of prior user intent scores for the user, the prior user intent scores being based at least in part on user behavior on the network directed to the category and the user intent scores being assigned to respective sequential time periods;
selecting a prior user intent score that is: (i) non-neglible, and (ii) associated with a time period that is most recent relative to prior user intent scores of the plurality that are also non-negligible; and
applying a decay function to the selected prior user intent score to generate a decayed user intent score for the most recent time period, the decay function based at least in part on:
a number of time periods between the most recent time period and the time period associated with the selected prior user intent score; and
a number of time periods over which the selected prior user intent score will decay to a negligible amount.

8. The method of claim 7, wherein the number of time periods over which the selected prior user intent score will decay to a negligible amount is a fixed number of time periods.

9. The method of claim 7, wherein the negligible user intent score is zero.

10. The method of claim 7, wherein the time periods are measured in days, hours, or minutes.

11. The method of claim 7, wherein the decay function is further based at least in part on a square root function.

12. The method of claim 7, wherein the decay function is further based at least in part on an exponential function and a square root function.

13. The method of claim 7, wherein the category is a first category of a taxonomy of products or services being advertised on the network.

14. A system comprising:
a user behavior component that accesses a user behavior log stored in memory, the user behavior log storing actions of a user for a plurality of discrete sequential time periods, the actions of the user being directed to a category of products or services being advertised on a network; and
a scoring component that: (1) generates a score for the user for a most recent time period based at least in part on actions of the user stored in the user behavior log and directed at the category for the most recent time period, and (2) when the generated score is negligible, generates an adjusted score for the most recent time period based at least in part on a prior score from a prior time period.

15. The system of claim 14 further comprising
a grouping component that groups the user associated with the adjusted score to other users that each have a score for the most recent time period that is within a specified range or statistically determined range based on the users scores; and
a category component that stores the category within a taxonomy of products and services that are advertised on the network.

16. The system of claim 14, wherein the adjusted score is based at least in part on a number of time periods between the most recent time period and a nearest time period in which the prior score was determined to be non-negligible.

17. The system of claim 16, wherein the adjusted score is further based in part on a number of time periods over which the prior score will decay to a negligible amount.

18. The system of claim 14, wherein the score of the user is representative of a degree to which the user has an intent to purchase an item within the category.

19. The system of claim 14, wherein the actions of the user comprises the user submitting a search query or viewing a particular page on the network.

20. The system of claim 14, wherein the discrete sequential time periods are measured in days, hours, or minutes.
